(19) United States
(12) Patent Application Publication
(10) Pub. No.: US 2018/0336598 A1
(43) Pub. Date: Nov. 22, 2018

(54) ITERATIVE CONTENT TARGETING

(71) Applicant: Facebook, Inc., Menlo Park, CA (US)

(72) Inventor: David S. Gross-Baser, Mountain View, CA (US)

(21) Appl. No.: 15/599,861

(22) Filed: May 19, 2017

(51) Int. Cl. G06Q 30/02; G06N 99/00

(52) U.S. Cl. CPC G06Q 30/0269; G06N 99/005; G06F 17/2818; G06Q 30/0277; G06Q 30/0255; G06Q 30/0251

(57) ABSTRACT

An online system iteratively targets content at users to improve the scope of a target audience for the content. The system receives the content from a content provider and determines an initial target audience for the content. The system provides members of the target audience with the content and monitors those users to determine which users interact with the content. A group of lookalike users is determined based on the characteristics of the users who interacted with the content. A new target audience is constructed, including the group of lookalike users, and the content is provided to the new target audience. The process is repeated one or more times to improve and expand the target audience.

### BACKGROUND

This invention relates generally to presentation of content via an online system, and in particular to iterative identification of additional users of an online system that are similar to an initial group of users.

Online systems presenting content to users, such as social networking systems, search engines, news aggregators, Internet shopping services, and content delivery services, allow content to be presented to large numbers of users. Hence, many online systems allow users to easily communicate content to other users of the online systems. Accordingly, online systems provide an ideal venue for presenting content identifying products or services provided by a content provider to users of the online system.

Traditionally, an audience of users is chosen to receive content using expertly determined demographic data or using machine learning to determine the characteristics of users who have expressed interest in the content when it is presented to them. That is, a computer model might be used to expand on an initial set of users based on the users from the initial set who have either expressed interest in the content or for whom the interest has been inferred. For example, experts could suggest that content such as a music video produced by a young pop group should be provided to users in their teens and early twenties who are known to be interested in music. However, this approach does not account for changing user tastes and it does not determine a full set of the users who may be interested in the content, since it uses a model to determine a target audience once, and subsequently sends the content only to the users in the static target audience.

### SUMMARY

An online system automatically selects and refines a targeting group of users based on a performance metric of a previously targeted group of users. The online system receives content from a content provider and determines an initial target audience for the content based on criteria for receiving the content identified by the content provider. Accordingly, members of the initial target audience are selected from a user profile store of the online system using the criteria for receiving the content identified by the content provider as a filter and the content is delivered to each user in the initial target audience. In one embodiment, the online system monitors the target audience and identifies a converting user group of the initial target audience that has interacted with the content or has performed some action in response to receiving the content. Characteristics of the converting user group are used as a seed for a lookalike expansion to generate a larger group of users who are similar to those users who converted on the content previously. Accordingly, this process can be iteratively repeated to further identify a second set of lookalike users based on users of the new target audience who also interacted with the content or performed some particular action in response to receiving the content. For example, the online system keeps track of users from a target audience who watch a music video, and repeatedly finds groups of similar users who have similar characteristics to expand and/or refine the target audience over a period of time.

In one embodiment, the online system may identify the initial target audience as part of a training set and identify a second target audience of lookalike users that is similar to the initial target audience for purposes of targeting content related to the content provider. The training set may be defined by target criteria of the content as users that have previously engaged with the content. Alternatively, the training set may be defined by target criteria of content as users that have interacted with the online system in a certain way, such as by expressing interest in a page, commenting within a page, installing an application, and engaging with the application. Accordingly, the online system generates training models based on the training set of users using information, such as past engagement history (e.g., click-through rates), demographic information, keywords associated with the training sets of users, and so forth. Confidence scores may be used to identify similar users across populations of users of the online system.

### BRIEF DESCRIPTION OF THE DRAWINGS

FIG. 1 is a block diagram illustrating a process for iteratively generating a target audience group of users of an online system, according to an embodiment.

FIG. 2 is a high level block diagram of a system environment of an online system, according to an embodiment.

FIG. 3 is an example block diagram of an architecture of the online system, according to an embodiment.

FIG. 4 illustrates a high level block diagram of the lookalike determination module 160 in further detail, in accordance with one embodiment.

FIG. 5 is a flowchart depicting a process for iteratively generating a target audience group of users of an online system, according to an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

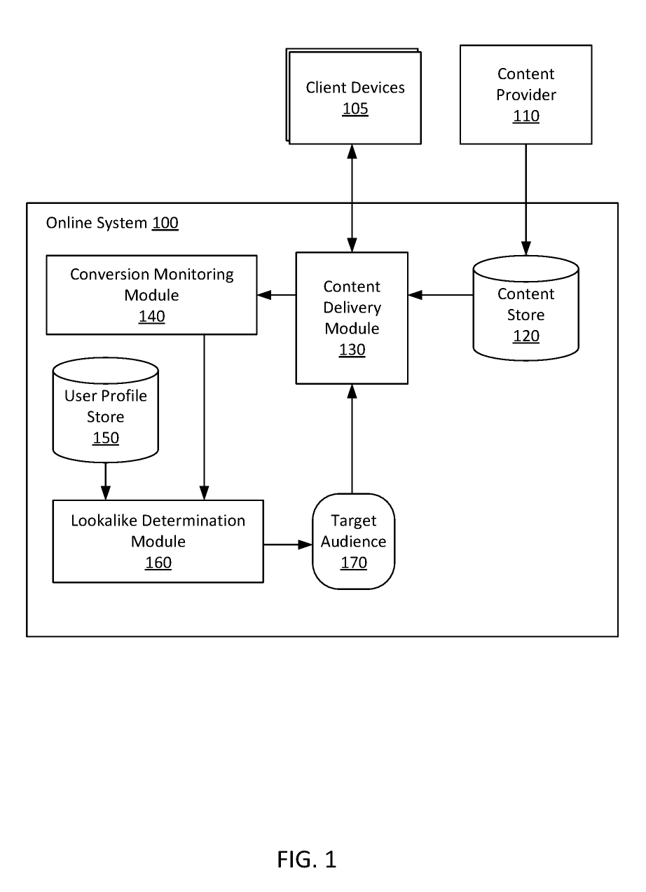

FIG. 1 is a block diagram illustrating a process for iteratively generating a target audience group of users of an online system, according to an embodiment. A third party content provider 110 provides content to an online system 100. Examples of content include images, text, hyperlinks, advertisements, videos, and the like. The online system 100 stores the content from the content provider 110 in content store 120. Content delivery module 130 retrieves content from content store 120 and prepares the content for transmission to one or more client devices 105. In this example, content delivery module 130 additionally selects an initial set of client devices 105 to receive a content item, and delivers the content item to the client devices 105 in the initial set. In some embodiments, the content provider 110 may request a specific initial target audience by specifying target criteria. For example, a content provider may choose specific user demographics to target content.

A conversion monitoring module 140 monitors the group of client devices 105 that received the content item. The conversion monitoring module 140 to identify which users complete a conversion by interacting with the content item on a client device 105. Users can “complete a conversion” by performing a particular action in response to receiving a content item. Examples of particular actions that may be tracked by the online system 100 include purchasing a product displayed in a content item, clicking on a content item, downloading an application described by a content item, or watching a video contained in a content item. One example of completing a conversion is watching a music video that has been provided as content.

The conversion monitoring module 140 provides a set of users who have completed a conversion on a content item (also referred to as a set of converting users) to a lookalike determination module 160. The lookalike determination module 160 collects information about the users who have completed a conversion (or converted) and uses the collected information to generate a computer model of users who are likely to interact with the content item.

The lookalike determination module 160 finds a plurality of users whose profiles, stored in a user profile store 150, exhibit characteristics of users who are likely to complete a conversion on the content item (also referred to as lookalike users). For example, if a subset of users who watch a music video also indicated their preference for “folk music” in their user profiles, then the online system 100 may choose other users who also indicated a preference for folk music. The lookalike determination module 160 uses the computer model to select a set of lookalike users from the user profile store 150. The selected set of lookalike users is added to a target audience 170 for the content item. The target audience contains users that have been newly selected by the lookalike determination module 160. The target audience may additionally contain some or all users who were previously members of a target audience for the content item.

The content delivery module 130 delivers the content item to the client devices 105 of users in the target audience. The process of delivering content to a set of users, monitoring the set of users for conversions, selecting a group of lookalike users, and creating a new target audience for the content may be repeated one or more times.

### System Architecture

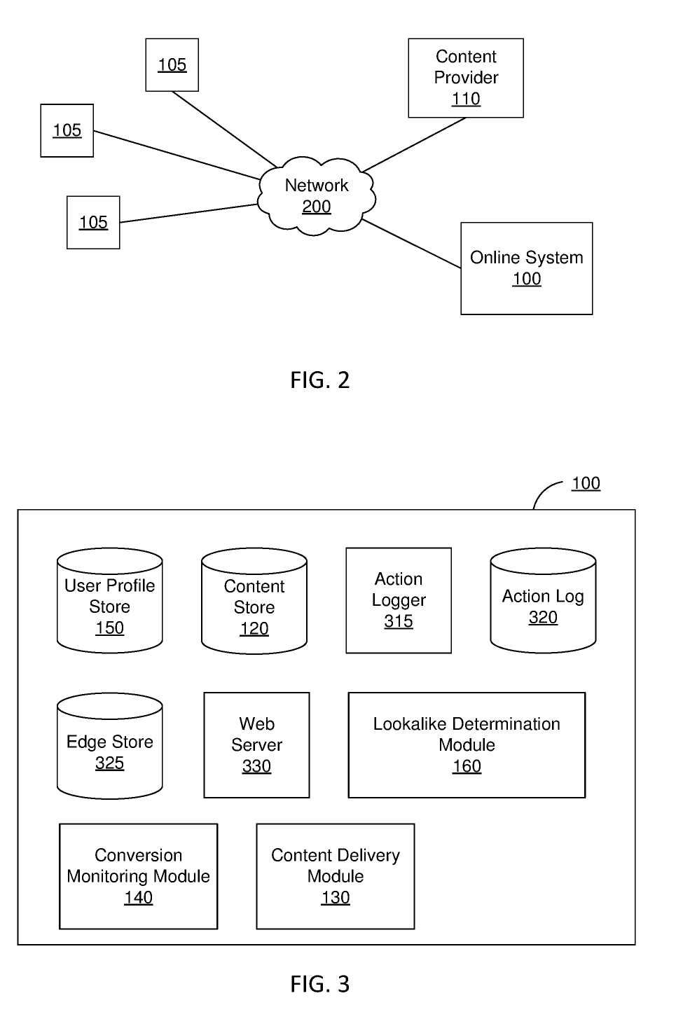

FIG. 2 is a high level block diagram of a system environment for an online system 100. The system environment shown by FIG. 2 comprises one or more client devices 105, a network 200, one or more content providers 110, and the online system 100. In alternative configurations, different and/or additional components may be included in the system environment. The embodiments described herein can be adapted to various kinds of online systems, such as social networking systems.

The client devices 105 are one or more computing devices capable of receiving user input as well as transmitting and/or receiving data via the network 200. A client device 105 is a conventional computer system, such as a desktop or laptop computer. Alternatively, a client device 105 may be a device having computer functionality, such as a personal digital assistant (PDA), a mobile telephone, a smartphone or another suitable device. A client device 105 is configured to communicate via the network 200. In one embodiment, a client device 105 executes an application allowing a user of the client device 105 to interact with the online system 100. For example, a client device 105 executes a browser application to enable interaction between the client device 105 and the online system 100 via the network 200. In another embodiment, a client device 105 interacts with the online system 100 through an application programming interface (API) running on a native operating system of the client device 105, such as IOS® or ANDROID™.

The client devices 105 are configured to communicate via the network 200, which may comprise any combination of local area and/or wide area networks, using both wired and/or wireless communication systems. In one embodiment, the network 200 uses standard communications technologies and/or protocols. For example, the network 200 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 200 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 200 may be represented using any suitable format, such as hypertext markup language (HTML) or extensible markup language (XML). In some embodiments, all or some of the communication links of the network 200 may be encrypted using any suitable technique or techniques.

One or more third party systems may be coupled to the network 200 for communicating with the online system 100, which is further described below in conjunction with FIG. 3. In one embodiment, a third party system is an application provider communicating information describing applications for execution by a client device 105 or communicating data to client devices 105 for use by an application executing on the client device 105. In other embodiments, a third party system is a content provider 110 that provides content or other information for presentation via a client device 105. A third party website may also communicate information to the online system 100, such as advertisements, content, or information about an application provided by the third party website.

FIG. 3 is an example block diagram of an architecture of the online system 100. The online system 100 shown in FIG. 3 includes a user profile store 150, a content store 120, an action logger 315, an action log 320, an edge store 325, a lookalike determination module 160, a conversion monitoring module 140, a content delivery module 130, and a web server 330. In other embodiments, the online system 100 may include additional, fewer, or different components for various applications. Conventional components such as network interfaces, security functions, load balancers, failover servers, management and network operations consoles, and the like are not shown so as to not obscure the details of the system architecture.

Each user of the online system 100 is associated with a user profile, which is stored in the user profile store 150. A user profile includes declarative information about the user that was explicitly shared by the user and may also include profile information inferred by the online system 100. In one embodiment, a user profile includes multiple data fields, each describing one or more attributes of the corresponding user of the online system 100. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the online system 100 displayed in an image. A user profile in the user profile store 150 may also maintain references to actions by the corresponding user performed on content items in the content store 120 and stored in the action log 320.

While user profiles in the user profile store 150 are frequently associated with individuals, allowing individuals to interact with each other via the online system 100, user profiles may also be stored for entities such as businesses or organizations. This allows an entity to establish a presence on the online system 100 for connecting and exchanging content with other online system users. The entity may post information about itself, about its products or provide other information to users of the online system 100 using a brand page associated with the entity's user profile. Other users of the online system 100 may connect to the brand page to receive information posted to the brand page or to receive information from the brand page. A user profile associated with the brand page may include information about the entity itself, providing users with background or informational data about the entity.

The content store 120 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 120, such as status updates, photos tagged by users to be associated with other objects in the online system 100, events, groups or applications. In some embodiments, objects are received from third-party applications separate from the online system 100. In one embodiment, objects in the content store 120 represent single pieces of content, or content “items.” Hence, users of the online system 100 are encouraged to communicate with each other by posting text and content items of various types of media through various communication channels. This increases the amount of interaction of users with each other and increases the frequency with which users interact within the online system 100.

The action logger 315 receives communications about user actions internal to and/or external to the online system 100, populating the action log 320 with information about user actions. Examples of actions include adding a connection to another user, sending a message to another user, uploading an image, reading a message from another user, viewing content associated with another user, and attending an event posted by another user, among others. In addition, a number of actions may involve an object and one or more particular users, so these actions are associated with those users as well and stored in the action log 320.

The action log 320 may be used by the online system 100 to track user actions on the online system 100, as well as actions on third party systems and content providers 110 that communicate information to the online system 100. Users may interact with various objects on the online system 100, and information describing these interactions are stored in the action log 320. Examples of interactions with objects include: commenting on posts, sharing links, checking-in to physical locations via a mobile device, accessing content items, and any other interactions. Additional examples of interactions with objects on the online system 100 that are included in the action log 320 include: commenting on a photo album, communicating with a user, establishing a connection with an object, joining an event to a calendar, joining a group, creating an event, authorizing an application, using an application, expressing a preference for an object (“liking” the object), and engaging in a transaction. Additionally, the action log 320 may record a user's interactions with advertisements on the online system 100 as well as with other applications operating on the online system 100. In some embodiments, data from the action log 320 is used to infer interests or preferences of a user, augmenting the interests included in the user's profile and allowing a more complete understanding of user preferences.

The action log 320 may also store user actions taken on a third party system, such as an external website, and communicated to the online system 100. For example, an e-commerce website that primarily sells sporting equipment at bargain prices may recognize a user of an online system 100 through a social plug-in enabling the e-commerce website to identify the user of the online system 100. Because users of the online system 100 are uniquely identifiable, e-commerce websites, such as this sporting equipment retailer, may communicate information about a user's actions outside of the online system 100 to the online system 100 for association with the user. Hence, the action log 320 may record information about actions users perform on a third party system, including webpage viewing histories, advertisements that were engaged, purchases made, and other patterns from shopping and buying.

In one embodiment, an edge store 325 stores information describing connections between users and other objects on the online system 100 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 100, such as expressing interest in a page on the online system 100, sharing a link with other users of the online system 100, and commenting on posts made by other users of the online system 100. Users and objects within the online system 100 can be represented as nodes in a social graph that are connected by edges stored in the edge store.

In one embodiment, an edge may include various features each representing characteristics of interactions between users, interactions between users and objects, or interactions between objects. For example, features included in an edge may describe a rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 100, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 325 also stores information about edges, such as affinity scores for objects, interests, and other users. Affinity scores, or “affinities,” may be computed by the online system 100 over time to approximate a user's affinity for an object, interest, and other users in the online system 100 based on the actions performed by the user. A user's affinity may be computed by the online system 100 over time to approximate a user's affinity for an object, interest, and other users in the online system 100 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 325, in one embodiment. Alternatively, each interaction between a user and a specific object is stored as a separate edge. In some embodiments, connections between users may be stored in the user profile store 150, or the user profile store 150 may access the edge store 325 to determine connections between users.

The conversion monitoring module 140 monitors user interactions on the client devices 105 to identify users who interact with content when it is displayed on the client devices 105. User interactions monitored by the conversion monitoring module 140 can include purchasing products or services after viewing or interacting with content that is related to those products or services, clicking on a link included in a content item, registering with a website or organization associated with a content provider after viewing a content item, and the like. For example, the conversion monitoring module 140 may collect data such as information about users who have watched a particular music video, or information about users who click on a link. In some embodiments, the conversion monitoring module additionally tracks rates at which users interact with content. For each content provider, campaign, or content item, the conversion monitoring module 140 determines a set of converting users, based on the collected conversion data, and transmits the set of converting users to the lookalike determination module 160, for use in selecting lookalike users who may also interact with the content item.

In one embodiment, the conversion monitoring module 140 uses a tracking pixel or piece of HTML code placed by the content provider 110 on third-party websites to monitor users visiting the websites that have not opted out of tracking. A tracking pixel might be included on various pages, including on a product page describing a product, on a shopping cart page that the user visits upon putting something into a shopping cart, on a checkout page that the user visits to checkout and purchase a product, etc. For example, a tracking pixel results in a transparent 1×1 image, an iframe, or other suitable object being created for third party pages. When a user's browser loads a page having the tracking pixel, the tracking pixel results in the user's browser attempting to retrieve the content for that pixel, and the browser contacts the online system 100 to retrieve the content. The request sent to the online system 100, however, actually includes various data about the user's actions taken on the third party website. The third party website can control what data is sent to the online system 100. For example, information may be included about a page the user is loading (e.g., is it a product page, a shopping cart page, a checkout page, etc.), about information on the page or about a product on the page of interest to the user (e.g., the SKU number of the product, the color, the size, the style, the current price, any discounts offered, the number of products requested, etc.), about the user (e.g., the third party's user identifier (UID) for the user, contact information for the user, etc.), and other data. In some embodiments, a cookie set by the online system 100 can also be retrieved by the online system 100, which can include various data about the user, such as the online systems' UID for the user, information about the client device and the browser, such as the Internet Protocol (IP) address of the client device, among other data. Tracking can also be performed on mobile applications of content providers by using a software development kit (SDK) of the online system 100 or via an application programming interface (API) of the online system 100 to track events (e.g., purchases) that occur by users on the content provider's app that are reported to the online system 100.

The lookalike determination module 160 determines a set of users who are similar to users who have performed a conversion in relation to a content item, and who are thus determined to be likely to perform a conversion in relation to the same content item. According to one embodiment, the lookalike determination module 160 comprises a computer model that is trained using characteristics from the user profiles of users who are known to have completed a conversion for the content item. In one embodiment, the lookalike determination module 160 determines specific indicator values that are common among all or some of the users in the group of converting users, and selects new users for the target audience by collecting user profiles that have similar indicator values. In one embodiment, lookalike determination module 160 uses a lookalike expansion technique based on a cluster model that has been trained to determine a measure of similarity between characteristics of users and users who have performed a conversion in relation to a content item. This expansion method is further described in U.S. patent application Ser. No. 13/297,117, filed on Nov. 15, 2011; U.S. patent application Ser. No. 14/290,355, filed on May 29, 2014; and U.S. patent application Ser. No. 14/616,543, filed on Feb. 6, 2015; which are hereby incorporated by reference in their entirety.

The content delivery module 130 delivers content to the client devices 105. This may involve formatting the content, queuing a set of content items for display, or otherwise preparing the content items for distribution to users.

The web server 330 links the online system 100 via the network 200 to the one or more client devices 105, as well as to the one or more third party systems. The web server 330 serves web pages, as well as other web-related content, such as JAVA®, FLASH®, XML and so forth. The web server 330 may receive and route messages between the online system 100 and the client device 105, for example, instant messages, queued messages (e.g., email), text messages, short message service (SMS) messages, or messages sent using any other suitable messaging technique. A user may send a request to the web server 330 to upload information (e.g., images or videos) that is stored in the content store 120. Additionally, the web server 330 may provide application programming interface (API) functionality to send data directly to native client device operating systems, such as IOS®, ANDROID™, WEBOS® or RIM®.

### Determining Lookalike Users

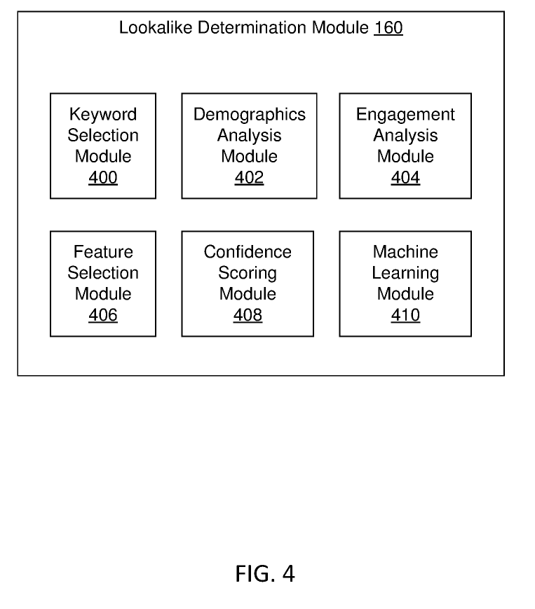

FIG. 4 illustrates a high level block diagram of the lookalike determination module 160 in further detail, in accordance with one embodiment. The lookalike determination module 160 includes a keyword selection module 400, a demographics analysis module 402, an engagement analysis module 404, a feature selection module 406, a confidence scoring module 408, and a machine learning module 410. These modules may perform in conjunction with each other or independently to develop a user model for determining a target audience of users based on a set of converting users on the online system 100.

The keyword selection module 400 determines keywords to be selected for a user model that describe users in a set of converting users who have interacted with a particular content item and/or content provider. A keyword profile may be maintained for each user of the online system 100 that includes keywords that describe the user based on the user's profile and actions performed by the user on the online system 100. For example, a user may express interest in broad categories of topics, such as dancing, sleeping, music, and jazz. Those keywords may be added to the user's keyword profile. Additionally, the user may interact with various objects on the online system 100 and outside of the online system 100 that indicate an interest in certain objects. For example, a user may share hyperlinks about celebrity gossip, perform searches on the online system 100, install gaming applications, interact with posts on pages on the online system 100, and the like. Through a user's interactions on the online system 100, as well as the user's interactions with external systems captured by the online system 100, a keyword profile for the user may be populated with thousands of keywords. The keyword selection module 400 analyzes the keyword profiles of the users in the set of converting users that have engaged with the content item or content provider to determine a set of keyword features for the user model. In one embodiment, a predetermined number of keywords are reduced from each user's keyword profile (e.g., 100 keywords) to be selected for the user model.

A demographics analysis module 402 analyzes demographic information about the set of converting users for generating a user model. In one embodiment, the demographics analysis module 402 analyzes various demographic information about the users in the set of converting users, including age, gender, political views, education status, college year, relationship status, gender(s) interested in dating, and geographic location information. In this way, the demographics analysis module 402 may select types of demographic information as features for a user model for a content item based on a type of demographic information being statistically relevant, in one embodiment. For example, if a set of converting users included, disproportionately, female users aged 18-35, the age and gender demographic types may be included as features in the user model for the content item. In another embodiment, the demographics analysis module 402 may include all demographic types as features in the user model for the content item or content provider. The demographics analysis module 402 may use the demographics information about the set of converting users in a machine learning model to generate a user model for the content item and/or content provider.

An engagement analysis module 404 analyzes the engagement of users in the set of converting users. In one embodiment, past click behaviors of the converting users are analyzed to determine a distribution of past click behavior by the users in the set of converting users. The converting users may be mapped to bins according to the distribution of past click behavior. After the user model is created and applied to the total population of users of the online system, the total population of users is mapped to the same bins, each according to their distribution of past click behavior and the same percentage of users are selected from the bins. As a result, the conversion rates of the users in the set of converting users may be normalized to avoid selecting users that interact with all content.

In another embodiment, the engagement analysis module 404 analyzes other engagement information about the users in the set of converting users, such as expressing interest in a page on the online system 100 (becoming a “fan” of a page or “liking” a page) and installing an application on the online system 100. Users may be sorted by their distribution of engagement with content providers on the online system 100 into bins in a similar way as described above. For example, users may be segmented by the number of pages on the online system 100 that the users have expressed interest in or by the number of applications the users have installed on the online system 100. Once the user model has been generated for the content item and/or content provider based on set of converting users and applied to the total population of users, the same percentage of users may be selected from the bins to normalize the engagement information of the users in the set of converting users.

A feature selection module 406 determines features for generating the user model based on the set of converting users that engaged with the content item or content provider. In one embodiment, a predetermined number of features are selected for the types of user characteristics analyzed about the set of converting users, including keywords, demographics, and engagement. For example, 100 keyword features may be selected from each user's keyword profile, where the top 10,000 keywords are considered. As another example, the past 75 clicks on content associated with content providers from each user's past click behavior during a predetermined time period may be used as features, where the top 10,000 content providers are considered. In another embodiment, the feature selection module 406 may select features for the user model based on statistically significant characteristics of the users in the set of converting users in comparison to the total population of users of the online system 100. For example, if users from urban regions that are interested in dance clubs are disproportionately engaging with a content provider or with a particular content item, as compared to the total population of users, then those features (urban regions and an interest in dance clubs) may be selected for the user model for the content item or content provider.

In one embodiment, the feature selection module 406 may select social graph features of users in the set of converting users when generating user models for content items or content providers. Various types of social graph features may be used in a user model, including a user being connected to multiple users in the set of converting users, a user being connected to at least one user in the set of converting users, a user interacting with multiple users in the set of converting users, and a user that regularly shares content with other users of the online system 100. For example, a user that is connected to a predetermined threshold number of users in the set of converting users may satisfy a social graph feature for the user model that increases a confidence score for that user, where a confidence score for a user may indicate a likelihood that the user will interact with the content and/or content provider 110. Social graph features may be determined by the online system 100 through analyzing edge objects associated with the users of the online system 100, as stored in the edge store 325.

A confidence scoring module 408 may be used to determine confidence scores for users of the online system based on a generated user model for a content provider or content item. Confidence scores may be determined based on whether users exhibit features in the user model. As a user exhibits more features in the user model for an content provider, the confidence score for that user increases. In one embodiment, after the total population of users of the online system 100 has been distributed into bins according to past engagement with content providers, confidence scores are assigned to the total population of users for a user model. The same percentage of users is selected from each of the bins to ensure normalization of engagement behavior. In one embodiment, the top confidence scoring users from each of the bins are selected.

A machine learning module 410 is used in the lookalike determination module 160 to select features for user models generated for content providers 110. In one embodiment, the online system 100 uses a machine learning algorithm to analyze user characteristics of users in the set of converting users, for example. The machine learning module 410 may select user characteristics as features for the user model for the content provider, such as keyword features, demographic features, and advertiser click features. The user model may be developed using at least one machine learning algorithm (e.g., decision trees, naïve Bayes classification, support vector machines, regression, etc.). In another embodiment, a machine learning algorithm may be used to optimize the selected features for a user model based on conversion rates of content items targeted to users identified from the user model. A selected feature in a user model may be removed based on a lack of engagement by users targeted by the content provider based on the user model that exhibits the selected feature. For example, a selected feature for a user model may include a high affinity score for Starbucks Coffee. However, if users exhibiting a high affinity score for Starbucks Coffee do not engage with the content item in expected numbers, then the machine learning algorithm may deselect the feature in the user model.

Any type of user information may be used as a feature in a user model, such as user tenure on the online system 100 and social graph information. User tenure may be defined as a period of time that the user has been part of the online system 100. Social graph information may include simple queries on connections of users in the converting user set as well as more complex queries about the strength and/or weakness of the connections of the users. For example, social graph information, such as whether users are close friends of the users in the training or mere acquaintances, may be used a feature in a user model.

Once a user model based on the training cluster of users is generated, a confidence score for each user of a population of users of the online system 100 is determined based on the user model. In one embodiment, confidence scores may be determined for a population of users of a particular geographic location, such as the United States. In another embodiment, confidence scores may be determined for a population of users of a particular community, network, or group. In yet another embodiment, confidence scores may be determined for all users of the online system 100.

Confidence scores may be determined for a total population of users of the online system 100 by distributing the total population of users into bins according to a distribution of engagement behavior history of the determined set of converting users, in one embodiment. For example, the set of converting users may include a spectrum of engagement behavior history, from users that interact with every content item to users that rarely interact with content items. The population of users may be distributed into the bins by analyzing each user's engagement behavior history, such as clicking on content items. Other types of engagement behavior may include users installing an application on the online system 100 associated with a content provider and users expressing interest in a page on the online system associated with a content provider.

As a result of determining confidence scores based on the user model for a population of users of the online system 100, lookalike users may be selected from the population of users based on the confidence scores. In one embodiment, a predetermined percentage of top confidence scoring users are selected from the bins. In this way, prior engagement behavior has been normalized. In another embodiment, users in the population of users that meet or exceed a predetermined threshold confidence score are selected as a set of lookalike users.

### Overall Process

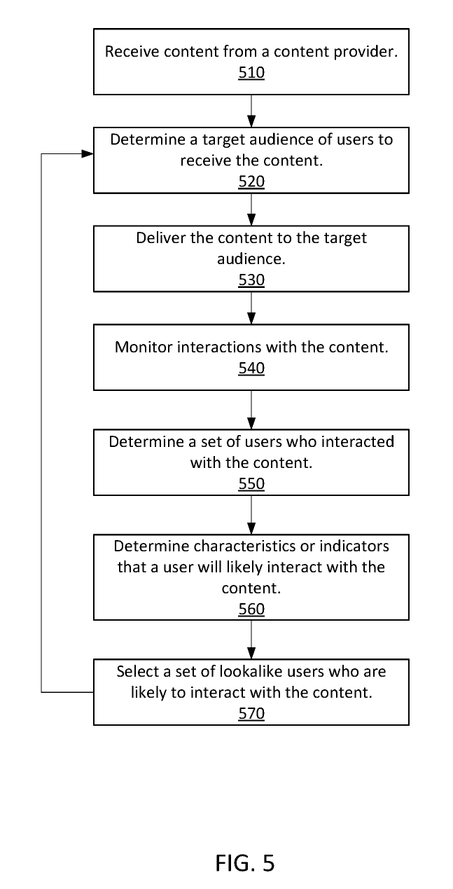

FIG. 5 is a flowchart depicting a process for iteratively generating a target audience group of users of an online system 100, according to an embodiment. The online system 100 receives 510 content from a content provider 110. Content includes individual content items such as images, text, videos, audio, or hyperlinks that can be displayed at a client device 105 where users can view or interact with them.

The online system 100 determines 520 a target audience of users. The first time an audience is determined for a specific content item, the determination may involve selecting a group of users at random, selecting a group of users based on expert opinions about which users are likely to be interested in the content item, selecting a group of users based on a target audience or demographic specified by a content provider 110, or otherwise selecting a group of users from the user profile store 150 to form an initial target audience for the content item.

The online system 100 delivers 530 the content item to the target audience. The content delivery module 160 formats the content item for presentation on the client devices 105 of each user in the target audience and delivers the content item to each user in the target audience.

The conversion monitoring module 140 monitors 540 the users in the target audience. Users who interact with the content are tracked. The conversion monitoring module 140 records instances of users who complete conversions with respect to the content item. Subsequent to exposing the users in the target audience to the content item, the online system 100 determines 550 a set of users who have interacted with the content. Interactions with the content include performing conversions in relation to the content.

The online system 100 determines 560 characteristics or indicators that are common among the users who interacted with the content. The common characteristics or indicators are used by the lookalike determination module 160 to select 570 a set of lookalike users who are likely to interact with the content item. In some cases, the set of lookalike users is selected by comparing the values of key characteristics and indicators in a converting user's profile with the values and characteristics associated with another user profile from the user profile store 150. The lookalike determination module may also use a machine learning model to determine which users from the user profile store 150 are most likely to perform a conversion after being presented with the content item.

Some or all of the selected lookalike users form all or a part of a new target audience that is determined 520 by the lookalike determination module 160. The process of determining 520 a target audience, delivering 430 the content item to users, monitoring 540 the users, determining 550 a set of users who interact with the content after receiving it, determining 560 common characteristics among those users, and selecting 570 a set of lookalike users to form or augment a target audience for the content item is repeated one or more times. In this way, a target audience iteratively converges on a set of all users in the user profile store 150 who will perform a conversion after viewing or interacting with the content item.

### CONCLUSION

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method for iteratively targeting content at users, the method comprising:
receiving, by an online system, one or more content items and targeting criteria for the one or more content items from a third-party content provider system, the online system maintaining user profiles for a plurality of users of the online system;
determining a target audience of users of the online system, the target audience of users being selected based on information from the user profiles for the plurality of users matching the targeting criteria; and
repeating, one or more times, a process comprising:
delivering the one or more content items to the target audience of users;
identifying a set of converting users from the target audience of users that interacted with the one or more content items;
determining, from the set of converting users, one or more characteristics of the set of converting users from user profiles of the set of converting users; and
refining the target audience of users based on the determined one or more characteristics of the set of converting users, the one or more characteristics being indicative of a likelihood that a user will interact with the one or more content items.

2. The method of claim 1, further comprising:
delivering the one or more content items to the refined target audience of users, wherein characteristics of to the refined target audience of users converting on the one or more content items are identified to further refine the target audience.

3. The method of claim 1, wherein determining the one or more characteristics of the set of converting users further comprises:
selecting characteristics from the user profiles of the set of the converting users that are statistically significant as compared to other characteristics for a population of users of the online system.

4. The method of claim 1, wherein the characteristics are selected from the group consisting of prior engagement behaviors of each user with the one or more content items, keywords in a user profile of a converting user, demographic information of each converting user, and connections of each converting user to other entities in the online system.

5. The method of claim 1, further comprising:
generating a model based on the user profiles of the set of converting users from the target audience of users that interact with the content, the model being configured to predict a likelihood that a subsequently presented user will interact with the one or more content items.

6. The method of claim 1, wherein identifying the set of converting users includes monitoring interactions between the target audience of users and the one or more content items.

7. The method of claim 1, wherein interacting with content includes following a hyperlink that is presented in the one or more content items.

8. The method of claim 1, wherein determining the characteristics indicative of a likelihood that a user will interact with the one or more content items includes:
comparing the user profiles of users who interact with the content; and
selecting shared characteristics for inclusion into a refined set of targeting criteria for the one or more content items.

9. The method of claim 1, wherein the refined target audience of users is larger than the target audience of users.

10. A non-transitory computer-readable storage medium including instructions that, when executable by one or more processors, causes an online system to:
receive one or more content items and targeting criteria for the one or more content items from a third-party content provider system, the online system maintaining user profiles for a plurality of users of the online system;
determine a target audience of users of the online system, the target audience of users being selected based on information from the user profiles for the plurality of users matching the targeting criteria; and
deliver the one or more content items to the target audience of users;
identify a set of converting users from the target audience of users that interacted with the one or more content items;
determine, from the set of converting users, one or more characteristics of the set of converting users from user profiles of the set of converting users; and
refine the target audience of users based on the determined one or more characteristics of the set of converting users, the one or more characteristics being indicative of a likelihood that a user will interact with the one or more content items.

11. The non-transitory computer-readable storage medium of claim 10, wherein the instructions that, when executed by the one or more processors, further causes the online system to:
deliver the one or more content items to the refined target audience of users, identify an additional set of converting users from the refined target audience of users that interacted with the one or more content items;
determine characteristics in common with the set of additional converting users; and
further refine the refined target audience of users based on the determined characteristics in common with the set of additional converting users.

12. The non-transitory computer-readable storage medium of claim 11, wherein the refined target audience of users is further refined based on the determined characteristics in common with the set of additional converting users and one or more characteristics of the set of converting users from user profiles of the set of converting users.

13. The non-transitory computer-readable storage medium of claim 10, wherein determining the characteristics indicative of a likelihood that a user will interact with the one or more content items includes:
comparing the user profiles of users who interact with the content; and
selecting shared characteristics for inclusion into a refined set of targeting criteria for the one or more content items.

14. The non-transitory computer-readable storage medium of claim 10, wherein the characteristics are selected from the group consisting of prior engagement behaviors of each user with the one or more content items, keywords in a user profile of a converting user, demographic information of each converting user, and connections of each converting user to other entities in the online system.

15. The non-transitory computer-readable storage medium of claim 10, wherein the refined target audience of users is larger than the target audience of users.

16. A computer system comprising:
one or more computer processors for executing computer program instructions; and
a non-transitory computer-readable storage medium storing instructions executable by the one or more computer processors to perform steps comprising:
receiving content from a content provider;
determining an initial target audience of users, the users selected from a user profile store; and
repeating, one or more times, the process of:
delivering the content to the target audience of users, wherein the target audience is the most recently determined target audience of users; monitoring the target audience of users;
determining, based on the monitoring, a set of users from the target audience of users that interact with the content;
determining characteristics indicative of a likelihood that a user will interact with the content based on user profiles of the set of users from the target audience of users who interact with the content;
selecting a set of lookalike users from the store of user profiles; and
constructing a target audience comprising the set of lookalike users.

17. The computer system of claim 16, wherein the set of lookalike users comprises users whose profiles have some or all of the characteristics determined to be indicative of a likelihood that a user will interact with the content.

18. The computer system of claim 16, wherein interacting with content includes following a hyperlink that is presented in the content.

19. The computer system of claim 16, further comprising building a model based on the user profiles of the set of users from the target audience of users that interact with the content, the model having the ability to predict the likelihood that a subsequently presented user will interact with the content.

20. The computer system of claim 16, wherein determining characteristics indicative of a likelihood that a user will interact with the content includes comparing the user profiles of users who interact with the content and selecting shared features.
